(19) United States
(12) Patent Application Publication
(10) Pub. No.: US 2011/0039190 A1
(43) Pub. Date: Feb. 17, 2011

(54) CONTINUOUS POROUS FLOW DISTRIBUTORS FOR A FUEL CELL

(75) Inventors: Jon P. Owejan, Honeoye, NY (US); Jeffrey J. Gagliardo, Gaithersburg, MD (US); Thomas A. Trabold, Pittsford, NY (US)

Correspondence Address: FRASER CLEMENS MARTIN & MILLER LLC, 28366 KENSINGTON LANE, PERRYSBURG, OH, 43551-4163, US

(73) Assignee: GM GLOBALTECHNOLOGY OPERATIONS, INC., DETROIT, MI (US)

(21) Appl. No.: 12/539,060

(22) Filed: Aug. 11, 2009

(51) Int. Cl. H01M 8/04

(52) U.S. Cl. 429/518; 429/210; 429/209; 429/532

(57) ABSTRACT

A fuel cell plate for a fuel cell assembly is provided that includes a pair of unipolar plates including a flow field, an inlet flow distributor, and an outlet flow distributor, wherein the flow distributors are produced from a porous material to control liquid water throughout the reactant flow path.

### FIELD OF THE INVENTION

The present disclosure relates to a fuel cell system and more particularly to a fuel cell system including a fuel cell plate having at least one porous flow distributor.

### BACKGROUND OF THE INVENTION

Fuel cell power systems convert a fuel and an oxidant to electricity. One type of fuel cell power system employs a proton exchange membrane (hereinafter “PEM”) to catalytically facilitate reaction of the fuel (such as hydrogen) and the oxidant (such as air or oxygen) to generate electricity. Water is a byproduct of the electrochemical reaction. The PEM is a solid polymer electrolyte that facilitates transfer of protons from an anode electrode to a cathode electrode in each individual fuel cell of a stack of fuel cells normally deployed in a fuel cell power system.

In the typical fuel cell assembly, the individual fuel cells have fuel cell plates with channels, through which various reactants and cooling fluids flow. Fuel cell plates may be unipolar, for example. A bipolar plate may be formed by combining unipolar plates. Movement of water from the channels to an outlet header and through a tunnel region underneath the seal which is formed by the joined fuel cell plates is caused by the flow of the reactants through the fuel cell assembly. Boundary layer shear forces and the reactant pressure aid in transporting the water through the channels and the tunnel region until the water exits the fuel cell through the outlet header.

A membrane-electrolyte-assembly (MEA) is disposed between successive plates to facilitate the electrochemical reaction. The MEA includes the anode electrode, the cathode electrode, and an electrolyte membrane disposed therebetween. Porous diffusion media (DM) are positioned on both sides of the MEA to facilitate a delivery of reactants, typically hydrogen and oxygen from air, for the electrochemical fuel cell reaction.

Water accumulation within the tunnel regions of the fuel cell results in poor performance of the fuel cell. Particularly, water accumulation causes reactant flow maldistribution in individual fuel cell plates and within the fuel cell assembly. Additionally, water remaining in the fuel cell after operation may solidify in sub-freezing temperatures, creating difficulties during a restart of the fuel cell. Prior solutions for effectively removing water from the fuel cell have led to increased manufacturing costs and the use of additional components.

Numerous techniques have been employed to remove water from the tunnel regions of the fuel cell. These techniques include pressurized purging, gravity flow, and evaporation. A pressurized gas purge at shutdown may be used to effectively remove water from the tunnel regions of fuel cells. Conversely, this purge increases required shutdown time of the stack and wastes fuel. Positioning of the stack appropriately may allow gravitational forces to remove water from the tunnel regions. Gravitational removal of water may be limited to tunnels having at least a certain diameter. Capillary forces of the conduit and corner wetting by the well known Concus-Finn condition minimize an effectiveness of gravitational removal of water. Water removal by evaporation is an insufficient technique as well. Evaporation can require costly heaters and may lead to an undesirable drying of the proton conducting materials. A dry fuel cell assembly may result in decreased proton conduction and prolong startup of the fuel cell.

The use of water transport structures and surface coatings are two methods that also allow the tunnel region of a fuel cell plate to transport water into a header region of the fuel cell assembly.

Water transport structures may be incorporated within the bipolar plate. Water transport structures may be disposed between an active region of the fuel cell and the outlet header. Water transport structures improve removal of liquid water from a fuel cell through a capillary action. While beneficial to the operation and a restart time of the fuel cell, adding water transport structures to the fuel cell assembly increases the number of components required to form the bipolar plate. Fabrication and assembly costs of the fuel cell assembly subsequently increase when components are added.

Surface coatings may also be used to facilitate a removal of water from the fuel cell. Hydrophobic or hydrophilic surface coatings may be used to increase or decrease the surface contact angle of the bipolar plate, aiding the ability of reactant shear forces and pressure to remove water from within the fuel cell or by preventing water films from forming. Coating precursors may be applied to the bipolar plate by spraying, dipping, or brushing, and formed into a hydrophobic or hydrophilic surface coating by secondary operations. Alternately, the coatings may be directly applied. While being less complex and expensive than water transport structures, surface coatings increase the fabrication costs of the bipolar plate.

There is a continuing need for a cost effective fuel cell plate that facilitates a transport of water therethrough that is inexpensive, minimizes the number of required components, and simplifies plate manufacture.

### SUMMARY OF THE INVENTION

In concordance and agreement with the present invention, a cost effective fuel cell plate that facilitates a transport of water therethrough that minimizes the number of required components, and simplifies plate manufacture, has been surprisingly discovered.

In one embodiment, a unipolar plate for a fuel cell comprises: a flow field adapted to distribute a reactant gas; an inlet flow distributor disposed adjacent the flow field to permit the reactant gas to enter the flow field; and an outlet flow distributor disposed adjacent the flow field to permit the reactant gas to exit the flow field, wherein at least one of the inlet flow distributor and the outlet flow distributor is produced from a porous material.

In another embodiment, a bipolar plate for a fuel cell comprises: a first plate including a flow field adapted to distribute a reactant gas to a cathode electrode of a membrane electrode assembly, an inlet flow distributor disposed adjacent the flow field to permit the reactant gas to enter the flow field, and an outlet flow distributor disposed adjacent the flow field to permit the reactant gas to exit the flow field, wherein at least one of the inlet flow distributor and the outlet flow distributor is produced from a porous material; and a second plate including a flow field adapted to distribute a reactant gas to an anode of a membrane electrode assembly, an inlet flow distributor disposed adjacent the flow field to permit the reactant gas to enter the flow field, and an outlet flow distributor disposed adjacent the flow field to permit the reactant gas to exit the flow field, wherein at least one of the inlet flow distributor and the outlet flow distributor is produced from a porous material.

In another embodiment, a bipolar plate for a fuel cell comprises: a first plate including a flow field having an inactive region and an active region adapted to distribute a reactant gas to a cathode electrode of a membrane electrode assembly, an inlet flow distributor disposed adjacent the flow field to permit the reactant gas to enter the flow field, and an outlet flow distributor disposed adjacent the flow field to permit the reactant gas to exit the flow field, wherein at least one of the inlet flow distributor and the outlet flow distributor is produced from a porous material, and wherein a first separator plate is disposed adjacent at least one of the flow field and the flow distributors; and a second plate including a flow field having an inactive region and an active region adapted to distribute a reactant gas to an anode of a membrane electrode assembly, an inlet flow distributor disposed adjacent the flow field to permit the reactant gas to enter the flow field, and an outlet flow distributor disposed adjacent the flow field to permit the reactant gas to exit the flow field, wherein at least one of the inlet flow distributor and the outlet flow distributor is produced from a porous material, and wherein a second separator plate is disposed adjacent at least one of the flow field and the flow distributors, the second separator plate abutting the first separator plate to form at least one channel therebetween.

### DRAWINGS

The above, as well as other advantages of the present invention will become readily apparent to those skilled in the art from the following detailed description, particularly when considered in the light of the drawings described hereafter.

FIG. 1 is a schematic cross-sectional elevational view of a fuel cell stack according to an embodiment of the invention;

FIG. 2 is a top plan view of a fuel cell of the fuel cell stack illustrated in FIG. 1;

FIG. 3 is an enlarged cross-sectional view of the fuel cell illustrated in FIG. 2 taken along section line 3-3; and

FIG. 4 is an enlarged cross-sectional view of the fuel cell illustrated in FIG. 2 taken along section line 4-4.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features.

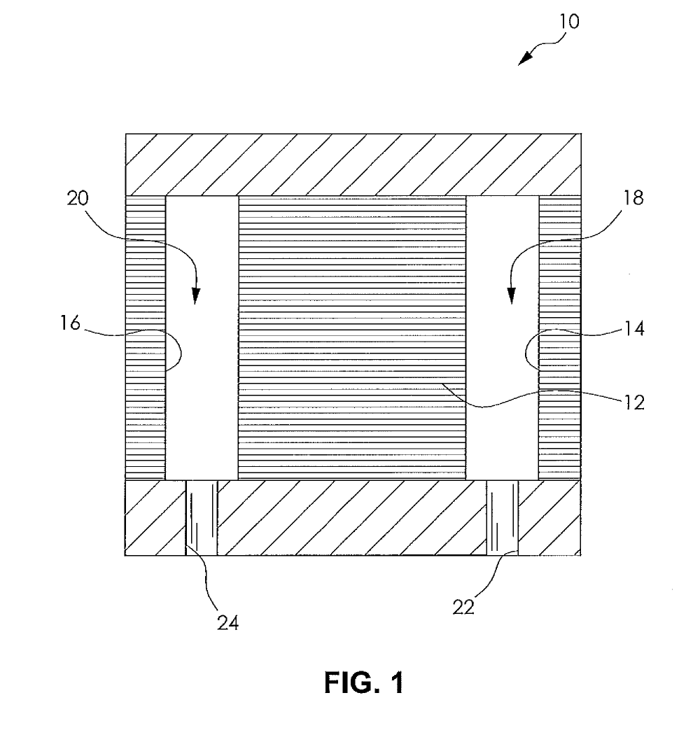

FIG. 1 shows a fuel cell assembly 10 according to an embodiment of the present disclosure. The fuel cell assembly 10 includes a plurality of stacked fuel cells 12. Each of the fuel cells 12 includes an inlet port 14 and an outlet port 16. The fuel cells 12 are stacked with the inlet port 14 and the outlet port 16 of each fuel cell 12 substantially aligned with the respective inlet port 14 and outlet port 16 of an adjacent plate or fuel cell 12. Collectively, the inlet ports 14 of each of the fuel cells 12 form an inlet header 18 and the outlet ports 16 of each of the fuel cells 12 form an outlet header 20. It is understood that the diameter, quantity, and length of the inlet header 18 will depend on the size and quantity of the inlet ports 14 in the fuel cells 12 and the number of fuel cells 12 stacked in the fuel cell assembly 10. It is further understood that the diameter, quantity, and length of the outlet header 20 will depend on the size and quantity of the outlet ports 16 in the fuel cells 12 and the number of fuel cells 12 stacked in the fuel cell assembly 10. An inlet 22 is in fluid communication with the inlet header 18 and an outlet 24 is in fluid communication with the outlet header 20. The fuel cell assembly 10 shown in FIG. 1 is illustrative of both an anode inlet header and anode outlet header, a cathode inlet header and cathode outlet header, and a coolant inlet header and coolant outlet header.

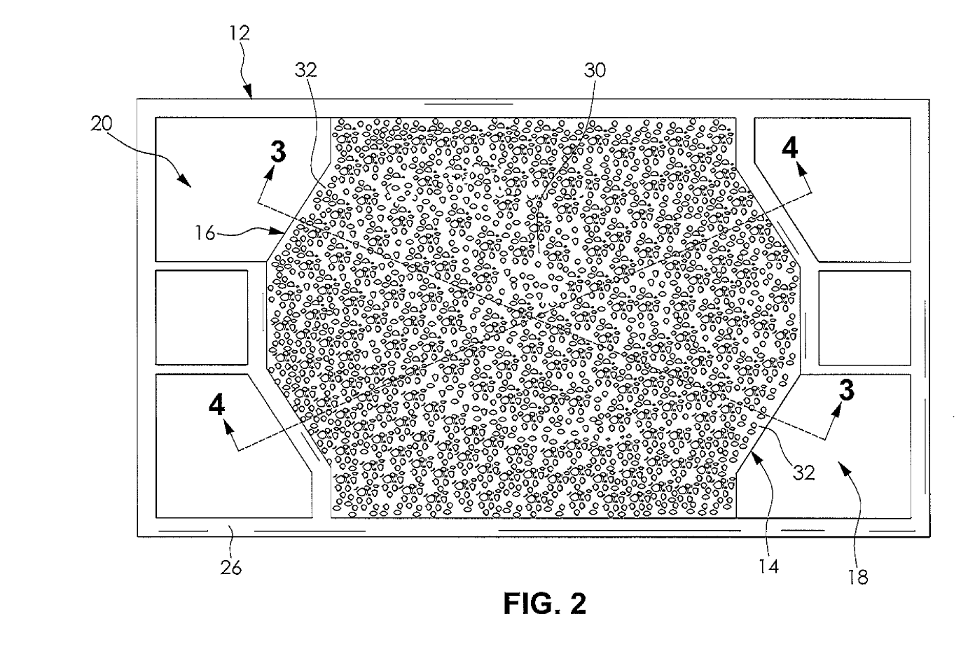

FIGS. 2-4 show one of the fuel cells 12 of the fuel cell assembly 10. The fuel cell 12 includes a pair of unipolar plates 26 and a pair of unipolar plates 28. Each of the unipolar plates 26, 28 includes an active region 30 and inactive regions 32. Typically, each of the unipolar plates 26 is bonded together with an adjacent unipolar plate 28 to form a bipolar plate 33. Bonding may be accomplished, for example, by brazing, diffusion bonding, laser welding, or gluing with a conductive adhesive, as is well known in the art. Suitable binders are known to those of skill in the art and can be chosen as desired. It is understood that the size, shape, quantity, and type of the unipolar plates 26, 28 in the fuel cell 12, and the configuration of the unipolar plates 26, 28 within the fuel cell 12, may vary based on design parameters such as the amount of electricity to be generated, the size of the machine to be powered by the fuel cell assembly 10, the desired volumetric flow rate of gases through the fuel cell assembly 10, and other factors, for example. A membrane electrode assembly (MEA) 34 is also included in the fuel cell 12. The MEA 34 is disposed between two successive bipolar plates 33. The MEA 34 includes a proton exchange membrane (PEM) 35 sandwiched between an anode electrode 36 and a cathode electrode 38.

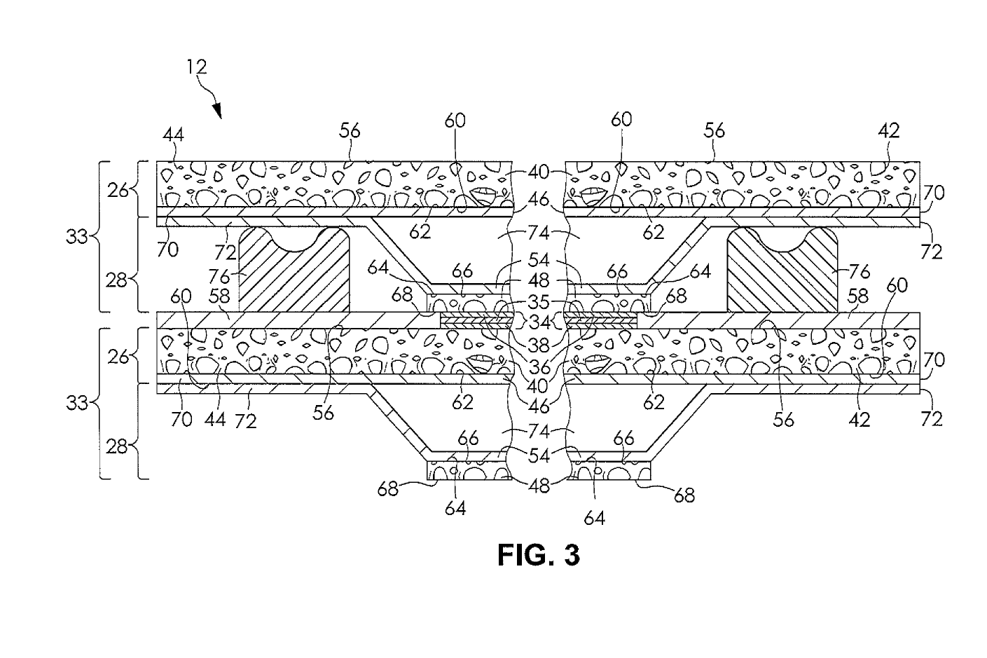

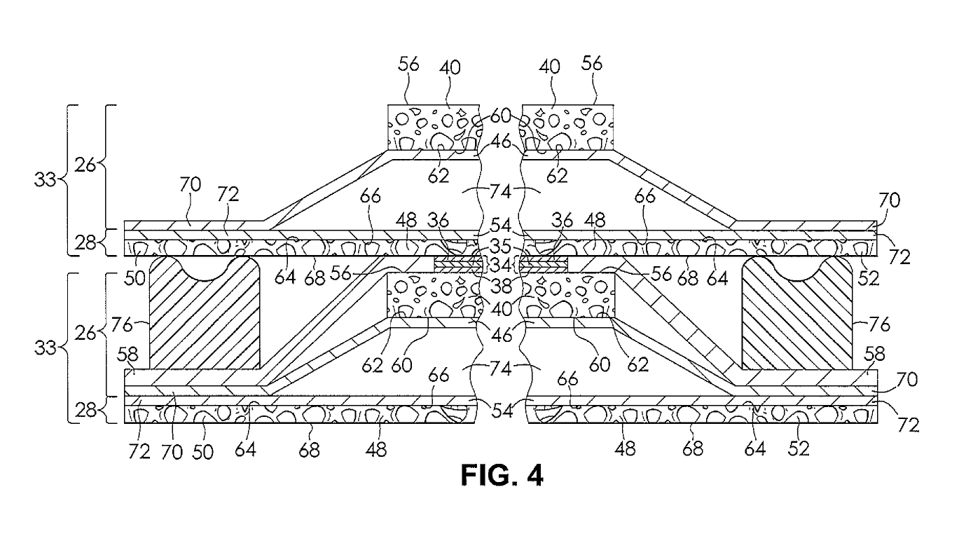

Referring now to FIGS. 3 and 4, the unipolar plate 26 includes a substantially porous flow field 40 integrally formed with a substantially porous inlet flow distributor 42 and a substantially porous outlet flow distributor 44. A separator plate 46 supports the flow field 40 and the flow distributors 42, 44 of the unipolar plate 26. The unipolar plate 28 includes a substantially porous flow field 48 integrally formed with a substantially porous inlet flow distributor 50 and a substantially porous outlet flow distributor 52. A separator plate 54 supports the flow field 48 and the flow distributors 50, 52 of the unipolar plate 28. Accordingly, the unipolar plates 26, 28 include a continuous, substantially porous layer from the inlet header 18 to the outlet header 20. It is understood that the flow fields 40, 48 of the respective unipolar plates 26, 28 can be formed separately from the respective flow distributors 42, 44, 50, 52 if desired. It is further understood that each of the flow fields 40, 48 can be a typical flow field configuration with a plurality of flow channels formed therein. It is understood that the flow fields 40, 48 and the flow distributors 42, 44, 50, 52 can be produced from any porous material as desired such as a metal mesh, a metal foam (e.g. nickel foam and stainless steel foam), a carbon-based foam (e.g. graphite foam), and a microtruss material, for example. Suppliers of such foams are Ultramet, Platingtech, Mitsubishi Materials Corporation, Siping AKS Metal Material Technology Corporation, Sumitomo Electric Industries, Ltd., and Porvair plc, for example. It is further understood that the flow fields 40, 48 and the flow distributors 42, 44, 50, 52 can be produced from an electrically conductive material, include an electrically conductive surface treatment, and the like, for example. In a non-limiting example, the flow fields 40, 48 and the flow distributors 42, 44, 50, 52 of the unipolar plates 26, 28 have a porosity of about 70% to about 85% and a pore size of about 50 μm to about 200 μm. In a further example, the pore size is about 120 μm. In the embodiment shown, the flow fields 40, 48 and the flow distributors 42, 44, 50, 52 are about 0.2 mm to about 1.0 mm thick. In a further non-limiting example, the flow distributors 42, 44 are about 0.6 mm thick and the flow distributors 50, 52 are about 0.4 mm thick. It should be recognized, however, that the flow fields 40, 48 and the flow distributors 42, 44, 50, 52 can be provided in any porosity, pore size, and thickness suitable for the unipolar plates 26, 28 as desired.

As shown, the inlet flow distributor 42 of the unipolar plate 26 is substantially planar and extends from the inlet header 18 to the flow field 40. The inlet flow distributor 50 of the unipolar plate 28 shown is substantially planar and extends from the inlet header 18 to the flow field 48. The inlet flow distributors 42, 50 permit reactants (not shown) to enter the fuel cell assembly 10 at the inlet header 18 and flow substantially uninterrupted to the flow fields 40, 48. The outlet flow distributor 44 of the unipolar plate 26 shown is substantially planar and extends from the flow field 40 to the outlet header 20. The outlet flow distributor 52 of the unipolar plate 28 shown is substantially planar and extends from the flow field 48 to the outlet header 20. The outlet flow distributors 44, 52 permit reactants to flow substantially uninterrupted from the flow fields 40, 48 to the outlet header 20 and exit the fuel cell assembly 10. The flow fields 40, 48 effectively distribute the reactants across the active region 30 of the unipolar plates 26, 28. Additionally, the flow distributors 42, 44, 50, 52 and the flow fields 40, 48 guide and facilitate movement of liquid water created during the electrochemical reaction through the active region 30 and inactive regions 32 of the unipolar plates 26, 28 and towards the outlet header 20. The liquid water is moved through the flow distributors 42, 44, 50, 52 and the flow field 40, 48 by reactant drag and capillary forces. As illustrated, the flow field 40 of the unipolar plate 26 permits the reactants to contact a substantial portion of the cathode electrode 38 of the MEA 34, contrary to a typical flow channel configuration The flow field 48 of the unipolar plate 28 permits the reactants to contact a substantial portion of the anode electrode 36 of the MEA 34, contrary to a typical flow channel configuration. At least one of the inactive regions 32 of the flow fields 40, 48 and the flow distributors 42, 44, 50, 52 may include a surface treatment to maximize liquid water management of the fuel cell assembly 10 and minimize a freezing at startup thereof. It is understood that the surface treatment can be any surface treatment as desired such as a hydrophobic surface treatment (e.g. a porous foam dipped in a hydrophobic material), a hydrophilic surface treatment (e.g. a porous foam dipped in a hydrophilic material), and the like, for example.

A first face 56 of the flow field 40 and the flow distributors 42, 44 of the unipolar plate 26 abuts at least one of the cathode electrode 38 of the MEA 34 and a subgasket 58 surrounding the MEA 34. A second face 60 of the flow field 40 and the flow distributors 42, 44 of the unipolar plate 26 abuts a first face 62 of the separator plate 46. As illustrated in FIG. 4, a first face 64 of the flow field 48 and the flow distributors 50, 52 of the unipolar plate 28 abuts a first face 66 of the separator plate 54. A second face 68 of the flow field 48 and the flow distributors 50, 52 abuts at least one of the anode electrode 36 of the MEA 34 and the subgasket 58.

The separator plates 46, 54 are substantially fluid impermeable, electrically and thermally conductive, and corrosion resistant sheets. The separator plates 46, 54 can be produced from at least one of a metal material and a non-metal material such as a stainless steel material, an aluminum material, a titanium material, a graphite material, and a composite material, for example. Any conventional method for forming the separator plates 46, 54 can be employed such as stamping, roll forming, pressure forming, and electromagnetic forming, for example. It should be recognized that the material and method of forming the separator plates 46, 54 can affect a formability of the separator plates 46, 54. As a non-limiting example, each of the separator plates 46, 54 is about 0.05 mm to about 0.2 mm thick. It is understood, however, that the separator plates 46, 54 can have any thickness as desired. The separator plates 46, 54 are substantially planar, although it is understood that the separator plates 46, 54 can have apertures and out-of-plane features such as indentations, channels, ribs, and the like, for example, as desired.

A periphery of the separator plates 46, 54 includes respective lands 70, 72 formed thereon. The land 70 of the separator plate 46 abuts the land 72 of the separator plate 54 to form at least one channel 74 therebetween. The at least one channel 74 is configured to receive a fluid such as a coolant, for example, to flow therethrough during an operation of the fuel cell assembly 10 and assist in thermal regulation thereof. It is understood that the at least one channel 74 can include a porous foam disposed therein, as desired. The at least one channel 74 is adapted to permit the flow of the fluid over more surface area of the unipolar plates 26, 28 and in closer proximity to the active regions 30 thereof, than a typical flow channel configuration. Accordingly, higher fluid temperatures and lower fluid volumes are permitted in the fuel cell assembly 10 than in a typical fuel cell assembly.

A support member 76 may be disposed between the subgasket 58 and at least one of the flow distributors 50, 52 and the land 72 of the separator plate 54. It is understood that the support member 76 and the subgasket 58 may be integrally formed. The subgasket 58 is substantially uniformly supported by at least one of the flow distributors 42, 44 and the separator plate 46, thereby minimizing complications caused by a continuous micro-channel design such as the subgasket 58 intruding into and restricting channels forming a feed region in the inactive regions 32 of the fuel cell assembly 10.

It should be appreciated that the present fuel cell 12 is cost-effective by eliminating additional components and manufacturing processes such as water transport structures, surface coatings, tunnel regions formed in the inactive regions 32, and the like. It is surprisingly found that the fuel cell 12 is effective in militating against water accumulation in the active regions 30 and the inactive regions 32 of the fuel cell assembly 10 and reactant maldistribution. The fuel cell 12 thereby maximizes starting performance of the fuel cell assembly 10 in sub-freezing temperatures.

Generally, during operation of a fuel cell system, the hydrogen reactant is fed into the anode electrode 36 of the fuel cell assembly 10. Concurrently, the oxygen reactant is fed into the cathode electrode 38 of the fuel cell assembly 10. At the anode electrode 36, the hydrogen is catalytically split into protons and electrons. The oxidation half-cell reaction is represented by: H₂⇄2H⁺+2e⁻. In a polymer electrolyte membrane fuel cell assembly, the protons permeate through the PEM 35 to the cathode electrode 38. The electrons travel along an external load circuit to the cathode electrode 38 creating the current of electricity of the fuel cell assembly 10. At the cathode electrode 38, the oxygen reacts with the protons permeating through the PEM 35 and the electrons from the external circuit to form water molecules. This reduction half-cell reaction is represented by: 4H⁺+4e⁻+O₂⇄2H₂O.

During operation of the fuel cell assembly 10, the inlet flow distributors 42, 50 allow for the reactants to enter the fuel cell 12 through the inlet header 18. The outlet flow distributors 44, 52 allow for the reactants and water produced during the electrochemical reaction to exit the fuel cell 12 through the outlet header 20. Particularly, droplets of liquid water are formed in the flow field 40 adjacent the cathode electrode 38 of the MEA 34. Some water also may be transported into the flow field 48 adjacent the anode electrode 36 of the MEA 34, or may form in the anode electrode 36 via condensation resulting from consumption of the hydrogen. The air stream flowing through the cathode electrode 38 causes the water droplets and water vapor to flow through the flow field 40 and the flow distributor 44 into the outlet header 20. It is understood that the operation as described herein for the cathode electrode 38 is similar to operation for the anode electrode 36 of the fuel cell assembly 10.

While certain representative embodiments and details have been shown for purposes of illustrating the invention, it will be apparent to those skilled in the art that various changes may be made without departing from the scope of the disclosure, which is further described in the following appended claims.

What is claimed is:

1. A unipolar plate for a fuel cell comprising:
a flow field adapted to distribute a reactant gas;
an inlet flow distributor disposed adjacent the flow field to permit the reactant gas to enter the flow field; and
an outlet flow distributor disposed adjacent the flow field to permit the reactant gas to exit the flow field, wherein at least one of the inlet flow distributor and the outlet flow distributor is produced from a porous material.

2. The unipolar plate according to claim 1, wherein the porous material of at least one of the inlet flow distributor and the outlet flow distributor is at least one of a metal mesh, a metal foam, a carbon-based foam, and a microtruss material.

3. The unipolar plate according to claim 1, wherein the flow field is a porous material produced from at least one of a metal mesh, a metal foam, a carbon-based foam, and a microtruss material.

4. The unipolar plate according to claim 1, wherein at least one of the flow field, the inlet flow distributor, and the outlet flow distributor is produced from at least one of an electrically conductive porous material and a porous material including an electrically conductive surface treatment.

5. The unipolar plate according to claim 1, further comprising a separator plate disposed adjacent at least one of the flow field, the inlet flow distributor, and the outlet flow distributor.

6. The unipolar plate according to claim 1, wherein the flow field is integrally formed with at least one of the inlet flow distributor and the outlet flow distributor.

7. The unipolar plate according to claim 1, wherein at least one of the flow field, the inlet flow distributor, and the outlet flow distributor includes at least one of a hydrophobic surface treatment and a hydrophilic surface treatment.

8. A bipolar plate for a fuel cell comprising:
a first plate including a flow field adapted to distribute a reactant gas to a cathode electrode of a membrane electrode assembly, an inlet flow distributor disposed adjacent the flow field to permit the reactant gas to enter the flow field, and an outlet flow distributor disposed adjacent the flow field to permit the reactant gas to exit the flow field, wherein at least one of the inlet flow distributor and the outlet flow distributor is produced from a porous material; and
a second plate including a flow field adapted to distribute a reactant gas to an anode electrode of a membrane electrode assembly, an inlet flow distributor disposed adjacent the flow field to permit the reactant gas to enter the flow field, and an outlet flow distributor disposed adjacent the flow field to permit the reactant gas to exit the flow field, wherein at least one of the inlet flow distributor and the outlet flow distributor is produced from a porous material.

9. The bipolar plate according to claim 8, wherein at least one of the flow field, the inlet flow distributor, and the outlet flow distributor of the first plate is produced from at least one of an electrically conductive porous material and a porous material including an electrically conductive surface treatment.

10. The bipolar plate according to claim 8, wherein at least one of the flow field, the inlet flow distributor, and the outlet flow distributor of the second plate is produced from at least one of an electrically conductive porous material and a porous material including an electrically conductive surface treatment.

11. The bipolar plate according to claim 8, further comprising a first separator plate disposed adjacent at least one of the flow field, the inlet flow distributor, and the outlet flow distributor of the first plate.

12. The bipolar plate according to claim 8, further comprising a second separator plate disposed adjacent at least one of the flow field, the inlet flow distributor, and the outlet flow distributor of the second plate.

13. The bipolar plate according to claim 8, wherein the flow field of the first plate is integrally formed with the inlet flow distributor of the first plate and the outlet flow distributor of the first plate.

14. The bipolar plate according to claim 8, wherein the flow field of the second plate is integrally formed with the inlet flow distributor of the second plate and the outlet flow distributor of the second plate.

15. The bipolar plate according to claim 8, wherein at least one of the flow field, the inlet flow distributor, and the outlet flow distributor of at least one of the first plate and the second plate includes at least one of a hydrophobic surface treatment and a hydrophilic surface treatment.

16. A bipolar plate for a fuel cell comprising:
a first plate including a flow field having an inactive region and an active region adapted to distribute a reactant gas to a cathode electrode of a membrane electrode assembly, an inlet flow distributor disposed adjacent the flow field to permit the reactant gas to enter the flow field, and an outlet flow distributor disposed adjacent the flow field to permit the reactant gas to exit the flow field, wherein at least one of the inlet flow distributor and the outlet flow distributor is produced from a porous material, and wherein a first separator plate is disposed adjacent at least one of the flow field and the flow distributors; and
a second plate including a flow field having an inactive region and an active region adapted to distribute a reactant gas to an anode electrode of a membrane electrode assembly, an inlet flow distributor disposed adjacent the flow field to permit the reactant gas to enter the flow field, and an outlet flow distributor disposed adjacent the flow field to permit the reactant gas to exit the flow field, wherein at least one of the inlet flow distributor and the outlet flow distributor is produced from a porous material, and wherein a second separator plate is disposed adjacent at least one of the flow field and the flow distributors, the second separator plate abutting the first separator plate to form at least one channel therebetween.

17. The bipolar plate according to claim 16, wherein at least one of the flow field, the inlet flow distributor, and the outlet flow distributor of the first plate is produced from at least one of an electrically conductive porous material and a porous material including an electrically conductive surface treatment.

18. The bipolar plate according to claim 16, wherein at least one of the flow field, the inlet flow distributor, and the outlet flow distributor of the second plate is produced from at least one of an electrically conductive porous material and a porous material including an electrically conductive surface treatment.

19. The bipolar plate according to claim 16, wherein the flow field of the first plate is integrally formed with the inlet flow distributor of the first plate and the outlet flow distributor of the first plate, and the flow field of the second plate is integrally formed with the inlet flow distributor of the second plate and the outlet flow distributor of the second plate.

20. The bipolar plate according to claim 16, wherein at least one of the inactive region of the flow field, the inlet flow distributor, and the outlet flow distributor of at least one of the first plate and the second plate includes at least one of a hydrophobic surface treatment and a hydrophilic surface treatment.
